(19) United States
(12) Patent Application Publication
(10) Pub. No.: US 2016/0347029 A1
(43) Pub. Date: Dec. 1, 2016

(54) MATERIAL COMPOSITE

(71) Applicant: Dr. Ing. h.c. F. Porsche Aktiengesellschaft, Stuttgart (DE)

(72) Inventor: Dominic Roemer, Weissach (DE)

(21) Appl. No.: 15/163,783

(22) Filed: May 25, 2016

(30) Foreign Application Priority Data
May 27, 2015 (DE) 10 2015 108 307.8

(51) Int. Cl. B32B 3/30; B32B 38/00; B32B 15/08; B32B 27/12; B32B 3/26; B32B 7/04

(52) U.S. Cl. CPC B32B 3/30; B32B 3/263; B32B 7/04; B32B 15/08; B32B 27/12; B32B 38/0012; B32B 2250/03; B32B 2398/20

(57) ABSTRACT

A material composite (1) has at least one metal layer (5) that is connected to a fiber-reinforced plastics matrix (10), and has an intermediate layer (12). To provide a material composite that is as stress-free as possible, the intermediate layer (12) engages into indentations (16) in the metal layer (5).

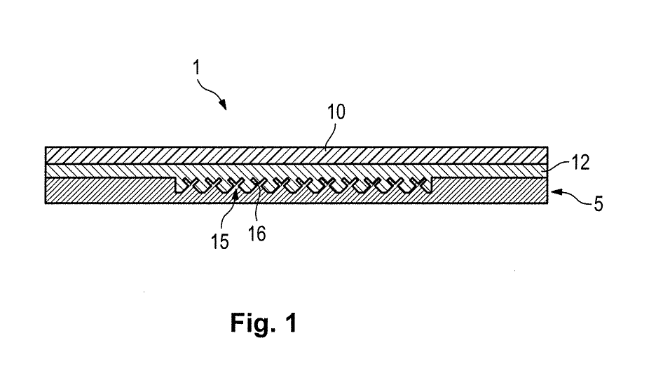

### CROSS REFERENCE TO RELATED APPLICATION

This application claims priority under 35 USC 119 to German Patent Appl. No. 10 2015 108 307.8 filed on May 27, 2015, the entire disclosure of which is incorporated herein by reference.

### BACKGROUND

1. Field of the Invention

The invention relates to a material composite having at least one metal layer that is connected to a fiber-reinforced plastics matrix and to an intermediate layer. The invention also relates to a method for producing such a material composite.

2. Description of the Related Art

US 2015/0030864 A1 discloses a structure with a plastics layer between a carbon fiber layer and a metal layer. DE 10 2011 082 697 A1 discloses a laminate comprising at least one fiber-reinforced plastics layer arranged between at least two metallic layers, and at least one boundary layer made of multiphase polymer blends or silane-modified thermoplastic/polymer blends arranged between the metallic layer and the plastics layer. DE 10 2008 058 786 A1 discloses a hybrid component that comprises a support structure consisting of a fiber composite material and a metal structure firmly connected thereto. The support structure is connected intimately to the metal structure via a thin intermediate layer of a highly elastic material. DE 101 34 372 A1 discloses a hybrid structure having a metal framework and a fiber-reinforced plastic part. The fiber is an endless fiber and the plastic part is connected directly to the metal framework.

It is an object of the invention to provide a material composite having at least one metal layer that is connected to a fiber-reinforced plastics matrix, and having an intermediate layer, where the material composite is as stress-free as possible.

### SUMMARY

The invention relates to a material composite having at least one metal layer connected to a fiber-reinforced plastics matrix, and an intermediate layer that engages into indentations in the metal layer. The intermediate layer advantageously enables a reduction of production-related stresses. The engagement of the intermediate layer in the indentations of the metal layer provides a particularly stable material composite.

The intermediate layer may be formed from the same plastics material as the fiber-reinforced plastics matrix, but is not fiber-reinforced. Thus, production of the material composite is simplified, and the stress reduction is improved.

The metal layer may be roughened locally to prepare the indentations. The local build up of the metal layer can proceed, for example, using a laser.

The plastics matric may be formed from a thermoplastic material. For reinforcement, fibers may be embedded into the thermoplastic material of the plastics matrix. The fibers, for example, may be glass fibers and/or carbon fibers. However, other fibers, such as special plastics fibers, may be embedded into the plastics material.

The intermediate layer may be formed from a thermoplastic material and may be the same thermoplastic material as the plastics matrix. As a result, production of the material composite is simplified further.

A method for producing the material composite may include locally roughening the metal layer to prepare the indentations. The metal layer may be a metal sheet. The metal sheet may be roughened in whole or in part on one side to prepare the indentations. The roughening creates an indented geometry that permits a positive-fit connection between the intermediate layer and the metal layer.

The method may include roughening the metal layer locally using a laser to prepare the indentations. The laser enables the metal layer to be roughened in regions in a simple manner.

The method may include forcing the intermediate layer into the indentations of the metal layer to produce a positive-fit connection to the metal layer thereby further simplifying the production of the material composite.

The method may be characterized in that the indentations of the metal layer are back-injection molded to the intermediate layer to produce a positive-fit connection to the metal layer. The material composite can be produced, for example, by injection molding, or injection stamping or transfer molding.

The invention also relates to a composite component made of an above described material composite produced according to an above described method. The composite component may be a motor vehicle component.

The invention optionally also relates to a motor vehicle having such a composite component.

Further advantages, features and details of the invention result from the description hereinafter, in which various exemplary embodiments are described in detail with reference to the drawing.

### BRIEF DESCRIPTION OF THE DRAWING

The sole accompanying FIGURE shows a material composite according to the invention in section.

### DETAILED DESCRIPTION

The accompanying FIGURE shows a material composite 1 having a metal layer 5 and a fiber-reinforced plastics matrix 10. The fiber-reinforced plastics matrix 10 is formed from a thermoplastic material into which fibers are embedded for reinforcement. An intermediate layer 12 is provided between the fiber-reinforced plastics matrix 10 and the metal layer 5.

The intermediate layer 12 may be formed of the same thermoplastic material as the fiber-reinforced plastics matrix 10.

The metal layer 5 has a roughened region 15 in which indentations 16 are provided into which the intermediate layer 12 engages.

Very high loads can occur locally in the production of temperature-stressed components that are produced from a metallic material and fibrous composite materials due to differing co-efficients of expansion of the various materials.

The combination of the intermediate layer 12 with the roughened region 15 of the metal layer 5 serves to lower unwanted stresses in the material composite 1.

In the roughened region 15, indented geometries are generated, for example using a laser. The intermediate layer 12 is forced into these indented geometries or indentations 16 to produce a positive-fit connection between the intermediate layer 12 and the metal layer 5.

When the intermediate layer 12 is formed from a thermoplastic material, production-related stresses frozen into the material composite 1 can be lowered by creep. Creep denotes, for example, a deformation and/or a flow of the intermediate layer 12.

The material composite 1 that is shown may be produced in large numbers by automation. The production advantageously proceeds under clean conditions, since, for example, no adhesive escapes.

The production method first includes producing the metal layer 5, for example as a metal sheet. The metal layer 5 then is roughened locally in the region 15 to generate the indentations 16.

The material composite 1 then is heated and pressed to connect the intermediate layer 12 in a positive-fit manner to the indentations 16 in the roughened region 15.

Alternatively, the indentations 16 in the roughened region 15 of the metal layer 5 can be back-injection molded with the thermoplastic material from which the intermediate layer 12 is formed.

Finally, a component from the material composite 1, after a sufficiently long cooling process, can be incorporated into a motor vehicle.

What is claimed:

1. A material composite comprising at least one metal layer having indentations, a fiber-reinforced plastics matrix, and an intermediate layer between the metal layer and the fiber-reinforced plastics matrix, the intermediate layer engaging into the indentations in the metal layer.

2. The material composite of claim 1, wherein the intermediate layer is formed from the same plastics material as the fiber-reinforced plastics matrix, but is not fiber-reinforced.

3. The material composite of claim 2, wherein the metal layer is roughened locally to prepare the indentations.

4. The material composite of claim 2, wherein the plastics matrix is formed from a thermoplastic material.

5. The material composite of claim 4, wherein the intermediate layer is formed from a thermoplastic material.

6. A method for producing a material composite, comprising: providing a metal layer; locally roughening a surface of the metal layer to prepare indentations; applying an intermediate layer to the surface of the intermediate layer so that the intermediate layer engages into the indentations in the metal layer; and applying a fiber-reinforced plastics matrix to the intermediate layer.

7. The method of claim 6, wherein the step of locally roughening the metal layer comprises using a laser to prepare the indentations.

8. The method of claim 6, wherein the step of applying the intermediate layer to the surface of the intermediate layer comprises forcing the intermediate layer into the indentations of the metal layer to produce a positive-fit connection to the metal layer.

9. The method of claim 6, wherein the indentations of the metal layer are back-injection molded to the intermediate layer to produce a positive-fit connection to the metal layer.
